(19) United States
(12) Patent Application Publication
(10) Pub. No.: US 2025/0389428 A1
(43) Pub. Date: Dec. 25, 2025

(54) SYSTEM AND APPARATUS FOR MOVING AIR IN AN OVEN

(71) Applicant: James Wallander, Keller, TX (US)

(72) Inventor: James Wallander, Keller, TX (US)

(21) Appl. No.: 18/753,856

(22) Filed: Jun. 25, 2024

(51) Int. Cl. F24C 15/32; A47J 37/06

(52) U.S. Cl. CPC F24C 15/322; A47J 37/0641; A47J 37/0664

(57) ABSTRACT

An apparatus for moving air in an oven includes a heat reactive housing configured to be positioned in an oven. A fan is located in the heat reactive housing and configured to draw air through the housing. The fan draws air through the housing to move the air from a first section of the oven to a second section of the oven.

### BACKGROUND

The present disclosure relates to an oven, and particularly, to a system and apparatus for moving air in an oven.

Generally, moving airflow within an oven makes baking and cooking more even. Airflow movement also makes the exterior of the food dryer and crisper which is why some airflow devices are known as “air fryers.” Air fryers can be expensive and take up additional space in the kitchen. Moreover, numerous air fryers have been recalled due to being fire hazards. Additionally, convection ovens have a fan apparatus as original equipment within the oven and move air about the interior of the oven but are more expensive than conventional ovens which do not have a fan apparatus. Currently, there is no way to convert a conventional oven into a convection oven or air fryer.

### SUMMARY

The present disclosure includes one or more of the features recited in the appended claims and/or the following features which, alone or in any combination, may comprise patentable subject matter.

According to a first aspect of the disclosed embodiments, an apparatus for moving air in an oven includes a heat reactive housing configured to be positioned in an oven. A fan is located in the heat reactive housing and configured to draw air through the housing. The fan draws air through the housing to move the air from a first section of the oven to a second section of the oven. A battery is located in the heat reactive housing and configured to power the fan.

In some embodiments of the first aspect, the battery may be insulated within the heat reactive housing to control a temperature of the battery. The fan may be formed from a heat reactive material. The first section of the oven may be positioned above the second section of the oven and the fan may draw the air downward to the second section. The first section of the oven may be positioned below the second section of the oven and the fan may draw the air upward to the second section. The housing may include at least one of a base and hanging mechanism that can be positioned on a rack inside the oven.

According to a second aspect of the disclosed embodiments, an apparatus for moving air in an oven includes a heat reactive housing configured to be positioned in an oven. The housing includes a first opening and a second opening. A channel is formed between the first opening and the second opening. A fan is located in the channel of the heat reactive housing and configured to draw air through the channel between the first opening and the second opening. The fan draws air through the channel to move the air from a first section of the oven to a second section of the oven.

In some embodiments of the second aspect, a battery may power the fan. The battery may be located in the heat reactive housing to control a temperature of the battery. The fan may be formed from a heat reactive material. The first opening may be a lower opening and the second opening may be an upper opening. The fan may draw air upward from the first opening to the second opening. The first opening may be a lower opening and the second opening may be an upper opening. The fan may draw air downward from the second opening to the first opening. The housing may include at least one of a base and hanging mechanism that can be positioned on a rack inside the oven. The apparatus may be removably positioned in the oven.

According to a third aspect of the disclosed embodiments, a system for moving air in an oven includes at least one air movement device. The at least one air movement device includes a heat reactive housing configured to be positioned in an oven. A channel is formed in the heat reactive housing. A fan is located in the heat reactive housing and configured to draw air through the channel. The fan draws air through the channel to move the air from a first section of the oven to a second section of the oven.

In some embodiments of the third aspect, two air movement devices may work in conjunction to move the air from a first section of the oven to a second section of the oven. The first section of the oven may be positioned above the second section of the oven and the at least one air movement device may draw the air downward to the second section. The first section of the oven may be positioned below the second section of the oven and the at least one air movement device may draw the air upward to the second section. The at least one air movement device may at least one of move the air clockwise through the oven and move the air counterclockwise through the oven. The at least one air movement device may move the air through a heat reactive basket.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a schematic view of a system for moving air in an oven;

FIG. 2 is a front elevation view of a fan apparatus of the system shown in FIG. 1 positioned on a rack in an oven;

FIG. 3 is a top plan view of the rack of the oven shown in FIG. 2 and arrow indicating possible placements of the fan apparatus on the rack;

FIG. 4 is a side elevation view of an airflow arrangement from a single fan apparatus;

FIG. 5 is a side elevation view of another airflow arrangement from a single fan apparatus;

FIG. 6 is a side elevation view of an airflow arrangement from a pair of fan apparatuses;

FIG. 7 is a side elevation view of another airflow arrangement from a pair of fan apparatuses;

FIG. 8 is a side elevation view of yet another airflow arrangement from a pair of fan apparatuses; and

FIG. 9 is a side elevation view of a further airflow arrangement from a pair of fan apparatuses;

FIG. 10 is a top plan view of another embodiment of the fan apparatus;

FIG. 11 is a front elevation view of an embodiment of the fan apparatus shown in FIG. 10; and

FIG. 12 is a front elevation view of a fan apparatus of the system shown in FIG. 1 hanging from the rack in the oven.

### DETAILED DESCRIPTION

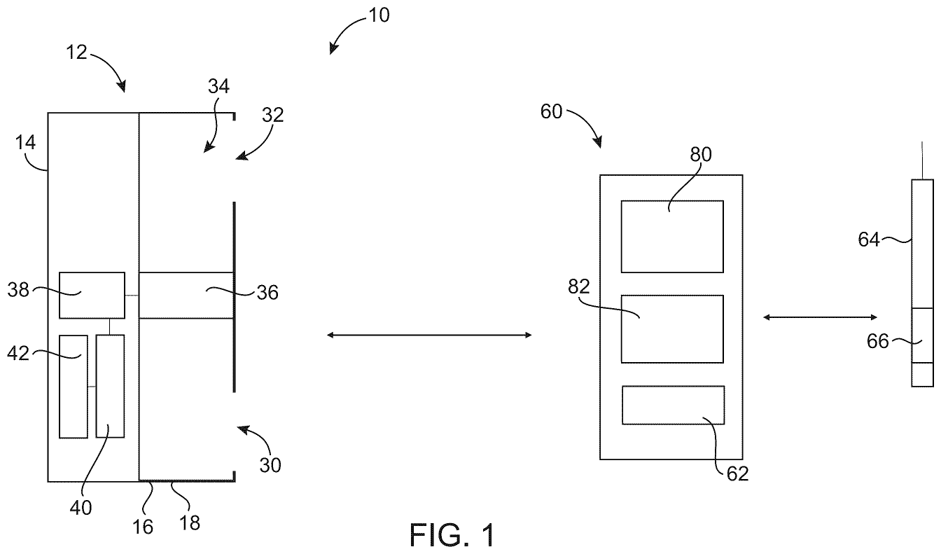

Referring to FIG. 1, a system 10 for moving air in an oven is provided. The system 10 enables a conventional oven to be converted into a convection oven or air fryer. In an exemplary embodiment, the system 10 saves electricity by allowing a user to cook at a lower temperature for a shorter period of time. For example, in some embodiments, the system 10 requires 20-25% less cooking time and temperature than a conventional oven. The system 10 includes a fan apparatus 12 that is configured to removably position in an oven. The fan apparatus 12 includes a heat reactive housing 14. As used herein “heat reactive” means any material that is at least one of heat resistant or heat reflective. A “heat resistant” material is any material that resists deformation from heat. A “heat reflective” material is any material that reflects heat from its surface. A “heat reactive” material can be any combination of heat resistant and heat reflective. The heat reactive material can include metals, plastics, polyimides, polymers, ceramics, and other heat resistant and heat reflective materials. In some embodiments, the housing 14 includes a highly heat-resistant and has no melting point. In some embodiments, the housing 14 can withstand continuous temperatures of 442° F. to 572° F. of repeated heat, and bursts of 899.6° F. without losing integrity. In some embodiments, the housing 14 is formed from aluminum or stainless steel. The housing 14 includes a base 16 that can be positioned on a rack inside the oven. The base 16 includes a flat surface 18 that prevents the fan apparatus 12 from tipping over in the oven. In some embodiments, the base 16 is contoured allowing the system 10 to fit more securely onto a rack structure within the oven.

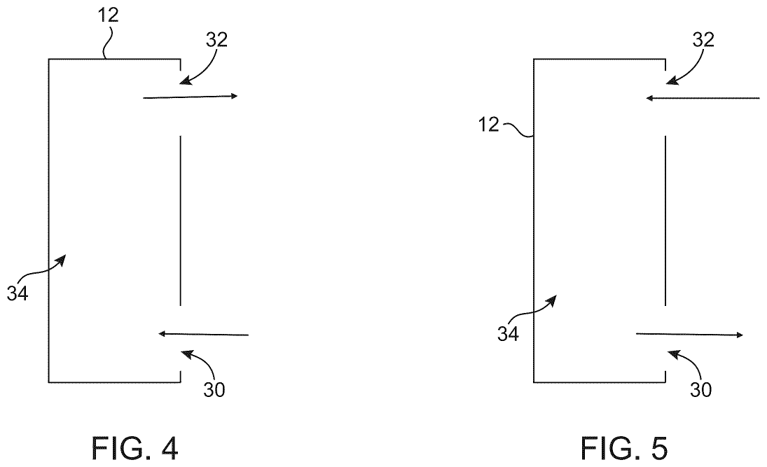

The housing 14 includes a lower opening 30 and an upper opening 32. A channel 34 is formed between the lower opening 30 opening and the upper opening 32. In some embodiments, the channel 34 is expandable and/or bendable to alter a position of the lower opening 30 relative to the upper opening 32. A fan 36 formed from heat reactive material is located in the housing 14 and configured to draw air through the housing 14. In particular, the fan 36 is located in the housing 14 and draws air between the lower opening 30 and the upper opening 32 to move the air from a first section of the oven to a second section of the oven. In some embodiments, the fan 36 is located in the channel 34. In some embodiments, the fan 36 is located outside of the channel 34. In some embodiments, the fan is positioned in housing 14 to create a vacuum to move air thought the channel 34. A direction of the fan 36 is reversible between clockwise and counter-clockwise to alter a direction of the airflow generated by the fan 36. As illustrated in FIG. 4, the fan 36 can be rotated to draw air into the lower opening 30 and move the air upward through the channel 34 to the upper opening 32 so that the air is discharged from the upper opening 32. As illustrated in FIG. 5, the fan 36 can be rotated to draw air into the upper opening 32 and move the air downward through the channel 34 to the lower opening 30 so that the air is discharged from the lower opening 30. In some embodiments, the fan 36 includes blades to move the air through the channel 34. In some embodiments, the fan 36 is bladeless.

The fan 36 is rotated by a motor 38 that is powered by a battery 40. Both the motor 38 and the battery 40 are sealed in the heat reactive housing 14 to insulate the motor 38 and the battery 40, thereby controlling a temperature of the motor 38 and the battery 40 and protecting the motor 38 and the battery 40 from degradation. In some embodiments, the battery 40 is rechargeable using a power cord or other suitable recharging device (for example inductive charging). In some embodiments, the battery 40 is replaceable. In some embodiments, the fan apparatus 12 includes more than one battery 40. A control system 42 including circuitry is provided to control the motor 38. The control system 42 is also sealed in the heat reactive housing 14 to insulate the control system 42, thereby controlling a temperature of the control system 42 and protecting the control system 42 from degradation.

The fan apparatus 12 is configured to communicate with a remote device 60 outside of the oven. In some embodiments, the remote device 60 is a computer. In the illustrated embodiment, the remote device 60 is a mobile device, such as tablet or phone. The remote device 60 operates an application or computer program to control the fan apparatus 12. That is, the remote device 60 includes a control system 62 having circuitry that communicates with the control system 42 of the fan apparatus 12. In some embodiments, the remote device 60 also communicates with thermometer 64. The thermometer 64 includes a control system 66 having circuitry that communicates with the control system 62 of the remote device. It will be appreciated that, in some embodiments, the fan apparatus 12 does not communicate with a remoted device. In such an embodiment, the fan apparatus 12 includes user inputs on the housing 14 to turn the fan apparatus on and off. In other embodiments, user inputs are provided on the housing 14 to control a speed of the fan 36.

The remote device 60 includes a display 80 that is configured to display information related to the fan apparatus 12 and the thermometer 64. In some embodiments, the display 80 displays a temperature of food in the oven as detected by the thermometer 64. In some embodiments, the remote device 60 includes an alarm notification to alert the user when an item in the oven reaches a predetermined temperature as detected by thermometer 64. The display 80 also displays a speed and direction of the fan 36. The remote device 60 also includes user inputs 82 for controlling the screens of the display 80. That is, the data on the display (fan speed, fan direction, oven temperature, food item temperature) can be toggled using the user inputs 82.

In one embodiment, the user inputs 82 are used to control the operation of the fan apparatus 12. For example, the user inputs 82 are used to alter the fan direction and/or the fan speed, in one embodiment. The user inputs 82 are also used to program the fan apparatus 12. As an example, the fan 36 can be programmed to rotate at a first speed for a predetermined period of time, and then rotate at second speed for another predetermined period of time. In one embodiment, the fan speed can be programmed to alter every predetermined number of minutes. As another example, the fan 36 can be programmed to rotate at the first direction for a predetermined period of time, and then rotate in the second direction for another predetermined period of time. In one embodiment, the fan direction can be programmed to alter every predetermined number of minutes. It will be appreciated that the fan 36 can be programmed to alter both speed and direction. In one embodiment, the speed and/or direction of the fan 36 is altered, in some embodiments, based on an internal temperature of the food in the oven as detected by the thermometer 64.

In some embodiments, the application running on the remote device 60 places ads on the display 80. In some embodiments, the ads include ingredients and/or recipes from third parties. In one embodiment, the ad links the user to a website of the third party. In some embodiments, the ingredients and/or recipes are displayed in application.

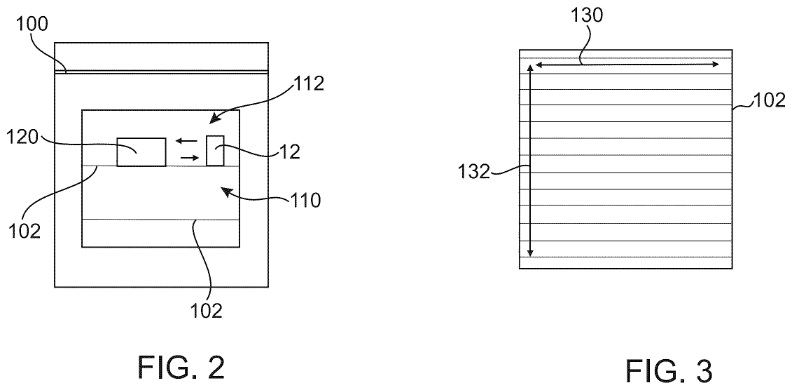

Referring now to FIG. 2, the fan apparatus 12 is removably positioned on a rack 102 of an oven 100. It will be appreciated that although the fan apparatus 12 is illustrated on a top rack 102 of the oven, the fan apparatus 12 is positionable on any rack 102 in the oven 100. It will also be appreciated, as described below, that any number of fan apparatuses 12 can be positioned in the oven 100. The fan apparatus 12 is configured to move air between a lower section 110 of the oven 100 and an upper section 112 of the oven 100. In the illustrated embodiment, the fan apparatus 12 draws air from the lower section 110 of the oven 100 to the upper section 112 of the oven. It will be appreciated that, consistent with FIG. 5, in some embodiments, the fan apparatus 12 draws air from the upper section 112 of the oven 100 to the lower section 110 of the oven. In an exemplary embodiment, the food is positioned in a basket 120 in the oven 100. The basket 120 is a heat reactive wire basket in an exemplary embodiment. The basket 120 allows the air moved by the fan apparatus 12 to flow through openings in the basket 120 into direct contact with the food.

Referring to FIG. 3, the rack 102 extends along an x-axis 130 and a y-axis 132. The fan apparatus 12 is positionable on a surface 134 of the rack 102 at any location along both the x-axis 130 and the y-axis 132. In some embodiments, multiple fan apparatuses 12 are positionable within the oven 100. In some embodiments, the fan apparatuses 12 are positioned to face one another and move the air toward one another. In embodiments, the fan apparatuses 12 are positioned facing approximately 90 relative to one another. In such an embodiment, a first fan apparatus 12 moves air flow across the air flow moved by the second fan apparatus 12. That is, the air flow of the first fan apparatus 12 moves at an angle (for example 90 degrees) relative to the air flow of the second fan apparatus 12. In the embodiment shown in FIG. 12, the fan apparatus 12 is positioned within the oven 100 by hanging the fan apparatus 12 from the rack 102 using an attachment mechanism 122, such as a hooking structure to loop around the rack 102 above the fan apparatus 12.

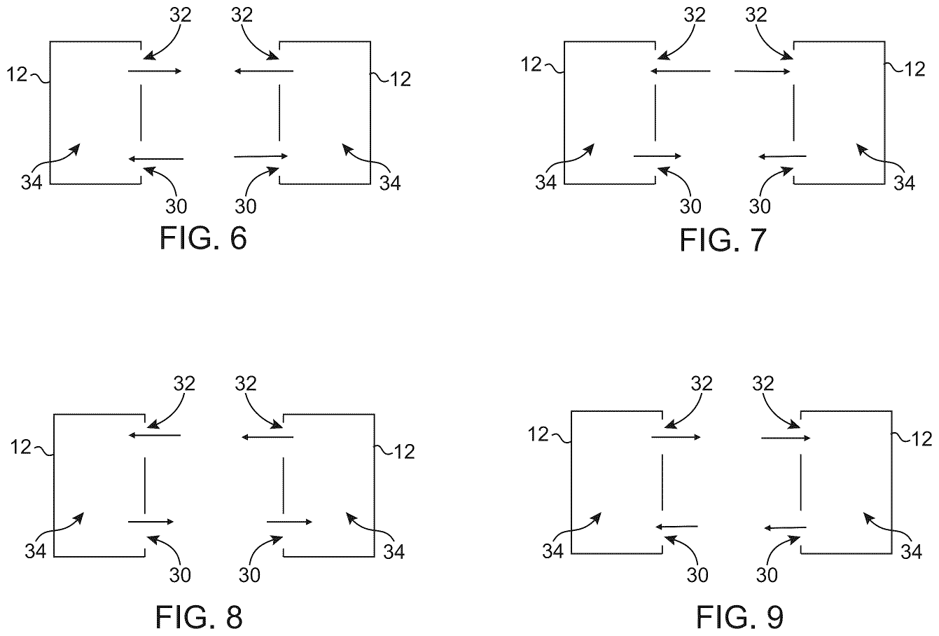

FIGS. 6-9 illustrate various airflows achievable with two fan apparatuses 12. It will be appreciated that these embodiments are illustrative only and other air flow configurations are achievable using more than a pair of fan apparatuses 12. In FIG. 6, both fan apparatuses 12 are programmed to move the air from the lower opening 30 to the upper opening 32. In FIG. 7, both fan apparatuses 12 are programmed to move the air from the upper opening 32 to the lower opening 30. In FIG. 8, the pair of fan apparatuses 12 are configured to move the air in a counter-clockwise direction. In FIG. 9, the pair of fan apparatuses 12 are configured to move the air in a clockwise direction. It will be appreciated that the application on the remote device 60 is usable to alter the air flows while in use or program the air flows to be altered. For example, in one embodiment, the fan apparatuses 12 are programmed to move the air clockwise for a predetermined time, and then move the air counter-clockwise for other predetermined period of time, to give just one example.

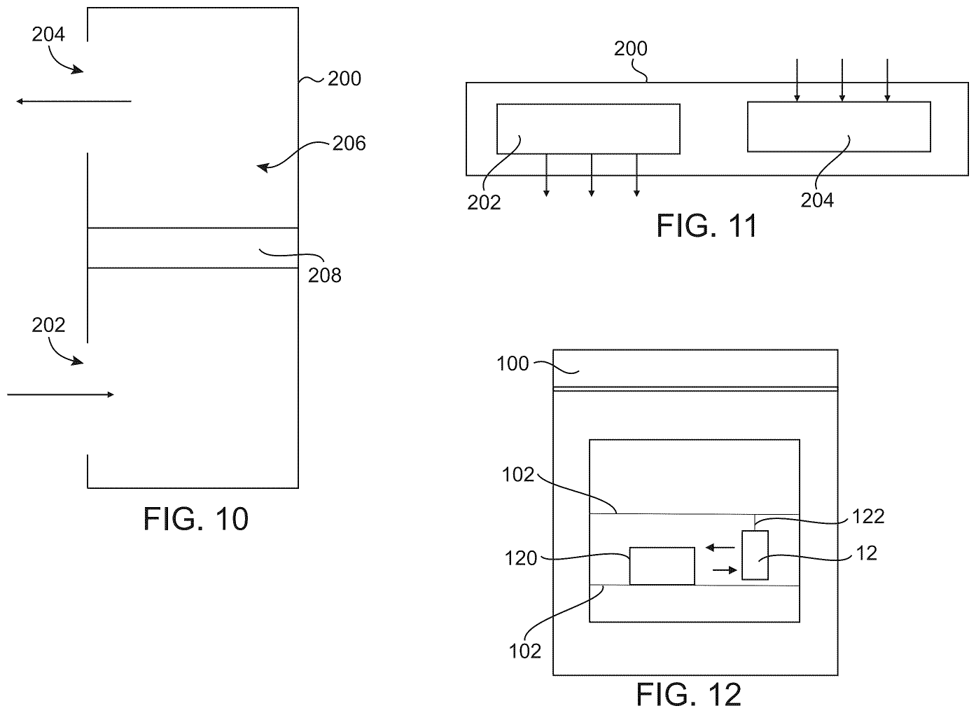

Referring to FIG. 10, a fan apparatus 200 includes a left side opening 202 and a right side opening 204. The left side opening 202 and the right side opening 204 are vertically aligned. That is, when the fan apparatus 200 is positioned on the oven rack 102, the left side opening 202 and the right side opening 204 are positioned at the same vertical height. The left side opening 202 and the right side opening 204 are horizontally separated and connected by a channel 206. A fan 208 in the fan apparatus 200 moves air between the left side opening 202 and the right side opening 204. The fan 208 is operable to move the air from the left side opening 202 to the right side opening 204 or to move the air from the right side opening 204 to the left side opening 202.

In an embodiment of the fan 200 shown in FIG. 11, the right side opening 204 is angled to draw air downward into the fan apparatus 200 and the left side opening 202 is angled to discharge air downward from the fan apparatus 200. It will be appreciated that, in some embodiments, the right side opening 204 is angled to draw air upward into the fan apparatus 200 and the left side opening 202 is angled to discharge air upward from the fan apparatus 200. It will also be appreciated that in some embodiments, the left side opening 202 is configured to draw air into the fan apparatus 200 and the right side opening 204 is configured to discharge the air from the fan apparatus 200.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. An apparatus for moving air in an electric oven, the apparatus comprising:
a heat reactive housing configured to be positioned in an electric oven,
a fan located in the heat reactive housing and configured to draw air through the housing, wherein the fan draws air through the housing to move the air from a first section of the electric oven to a second section of the electric oven, and
a battery located in the heat reactive housing and configured to power the fan,
wherein the battery is insulated within the heat reactive housing to control a temperature of the battery up to a temperature of 899.6° F. in the electric oven.

2. (canceled)

3. The apparatus of claim 1, wherein the fan is formed from a heat reactive material.

4. The apparatus of claim 1, wherein the first section of the electric oven is positioned above the second section of the electric oven and the fan draws the air downward to the second section.

5. The apparatus of claim 1, wherein the first section of the electric oven is positioned below the second section of the electric oven and the fan draws the air upward to the second section.

6. The apparatus of claim 1, wherein the housing includes at least one of a base or a hanging mechanism that can be positioned on a rack inside the electric oven.

7. An apparatus for moving air in an oven, the apparatus comprising:
a heat reactive housing configured to be positioned in an oven, wherein the housing includes a first opening and a second opening, wherein the first opening and the second opening are formed on the same side of the housing, and wherein a channel is formed between the first opening and the second opening,
a fan located in the channel of the heat reactive housing and configured to draw air through the channel between the first opening and the second opening, wherein the fan draws air through the channel to move the air from a first section of the oven to a second section of the oven,
wherein a speed of the fan is adjustable based on a program that is configured to rotate the fan at a first speed for a first predetermined period of time and to rotate the fan at a second speed for a second predetermined period of time, and
wherein a direction of the fan is adjustable between a first direction that draws the air from the first opening to the second opening and a second direction that draws the air from the second opening to the first opening.

8. The apparatus of claim 7, further comprising a battery to power the fan, wherein the battery is located in the heat reactive housing to control a temperature of the battery.

9. The apparatus of claim 7, wherein the speed and direction of the fan are controllable using a mobile device.

10. The apparatus of claim 7, wherein the fan is formed from a heat reactive material.

11. The apparatus of claim 7, wherein the first opening is a lower opening and the second opening is an upper opening, wherein the fan draws air upward from the first opening to the second opening.

12. The apparatus of claim 7, wherein the first opening is a lower opening and the second opening is an upper opening, wherein the fan draws air downward from the second opening to the first opening.

13. The apparatus of claim 7, wherein the housing includes at least one of a base or a hanging mechanism that can be positioned on a rack inside the oven.

14. The apparatus of claim 7, wherein the apparatus is removably positioned in the oven.

15. A system for moving air in an oven, the system comprising at least two air movement devices, wherein the at least two air movement devices each include:
a heat reactive housing configured to be positioned in an oven,
a channel is formed in the heat reactive housing,
a fan located in the heat reactive housing and configured to draw hot air from the oven through the channel, wherein the fan draws the hot air through the channel to move the hot air from a first section of the oven to a second section of the oven,
wherein the at least two air movement devices are arranged with openings facing one another to move the hot air in conjunction with one another so that each air movement device of the at least two air movement devices move air toward another air movement device of the at least two air movement devices.

16. (canceled)

17. The system of claim 15, wherein the first section of the oven is positioned above the second section of the oven and the at least one air movement device draws the hot air downward to the second section.

18. The system of claim 15, wherein the first section of the oven is positioned below the second section of the oven and the at least one air movement device draws the hot air upward to the second section.

19. The system of claim 15, wherein the at least one air movement device at least one of moves the hot air clockwise through the oven or moves the hot air counterclockwise through the oven.

20. The system of claim 15, further comprising a heat reactive basket, the at least one air movement device moves the hot air through the heat reactive basket.

21. An apparatus for moving air in an oven, the apparatus comprising:
at least two air movement devices configured to move air in conjunction with one another, wherein each of the at least two air movement device includes:
a heat reactive housing configured to be positioned in an oven, wherein the heat reactive housing is devoid of a heating element,
a fan located in the heat reactive housing and configured to draw air through the housing, wherein the fan draws air through the housing to move the air from a first section of the oven to a second section of the oven, and
a battery located in the heat reactive housing and configured to power the fan.
